(19) United States
(12) Patent Application Publication
(10) Pub. No.: US 2025/0111983 A1
(43) Pub. Date: Apr. 3, 2025

(54) COIL COMPONENT AND POWER SUPPLY APPARATUS

(71) Applicant: TDK CORPORATION, Tokyo (JP)

(72) Inventors: Yusuke TANIGUCHI, Tokyo (JP); Chiomi SATO, Tokyo (JP)

(73) Assignee: TDK CORPORATION, Tokyo (JP)

(21) Appl. No.: 18/899,839

(22) Filed: Sep. 27, 2024

(30) Foreign Application Priority Data
Sep. 29, 2023 (JP) 2023-170025

(51) Int. Cl. H01F 27/28; H01F 27/255

(52) U.S. Cl. CPC H01F 27/28; H01F 27/255

(57) ABSTRACT

A coil component may include a core portion including soft magnetic metal particles and a resin and a winding portion including a conductor wound. The winding portion may be inside the core portion. The core portion may include an axially central region and a coil corner neighboring region. The soft magnetic metal particles may include specific particles having a particle size of 10 μm or more and 50 μm or less. 0<D1/D2<1.00 may be satisfied, where D1 denotes an average inter-particle distance between the specific particles in the axially central region and D2 denotes an average inter-particle distance between the specific particles in the coil corner neighboring region.

The present application claims a priority to Japanese patent application No. 2023-170025 filed on Sep. 29, 2023, which is incorporated herein by reference in its entirety.

### BACKGROUND

The present disclosure relates to a coil component and a power supply apparatus.

Patent Document 1 discloses that improving uniformity of the inside of a molded body in which composite magnetic particles are pressure-molded improves DC superimposition characteristics of a reactor including the molded body as a core.
Patent Document 1: JP Patent Application Laid Open No. 2009-070885

### SUMMARY

A coil component according to one aspect of the present disclosure is
a coil component including:
a core portion including soft magnetic metal particles and a resin; and
a winding portion including a conductor wound,
wherein
the winding portion is inside the core portion;
the winding portion includes an inner circumferential surface, an outer circumferential surface, and an end surface;
the core portion includes an axially central region and a coil corner neighboring region;
the axially central region is located in a region within a predetermined range perpendicularly outwards from an axial centerline of the winding portion;
the coil corner neighboring region is within a predetermined range from a coil corner where the inner circumferential surface and the end surface meet;
the soft magnetic metal particles include specific particles having a particle size of 10 μm or more and 50 μm or less; and
0<D1/D2<1.00 is satisfied, where D1 denotes an average inter-particle distance between the specific particles in the axially central region and D2 denotes an average inter-particle distance between the specific particles in the coil corner neighboring region.

A power supply apparatus according to one aspect of the present disclosure includes the above coil component.

### BRIEF DESCRIPTION OF THE DRAWING(S)

FIG. 1 is a sectional schematic view of an inductor according to one example aspect of the present disclosure.

FIG. 2 is a sectional schematic view along line I-I shown in FIG. 1.

FIG. 3 is an enlarged view of a main part of FIG. 1.

FIG. 4 is a schematic view of a positional relationship between members used in a process of manufacturing an inductor according to one example aspect of the present disclosure before thermocompression bonding.

FIG. 5 is a schematic view of a positional relationship between members used in a process of manufacturing an inductor according to one example aspect of the present disclosure before thermocompression bonding.

### DETAILED DESCRIPTION

One embodiment of the present disclosure is described below with reference to the drawings. The following embodiment of the present disclosure is an exemplification illustrative of the present disclosure. Various elements, such as numerical values, shapes, materials, and manufacturing steps, according to the embodiment of the present disclosure can be modified or changed to the extent that technical problems do not arise.

Shapes and the like illustrated in the drawings of the present disclosure do not necessarily match actual shapes and the like, because the former may be modified for illustration purposes.

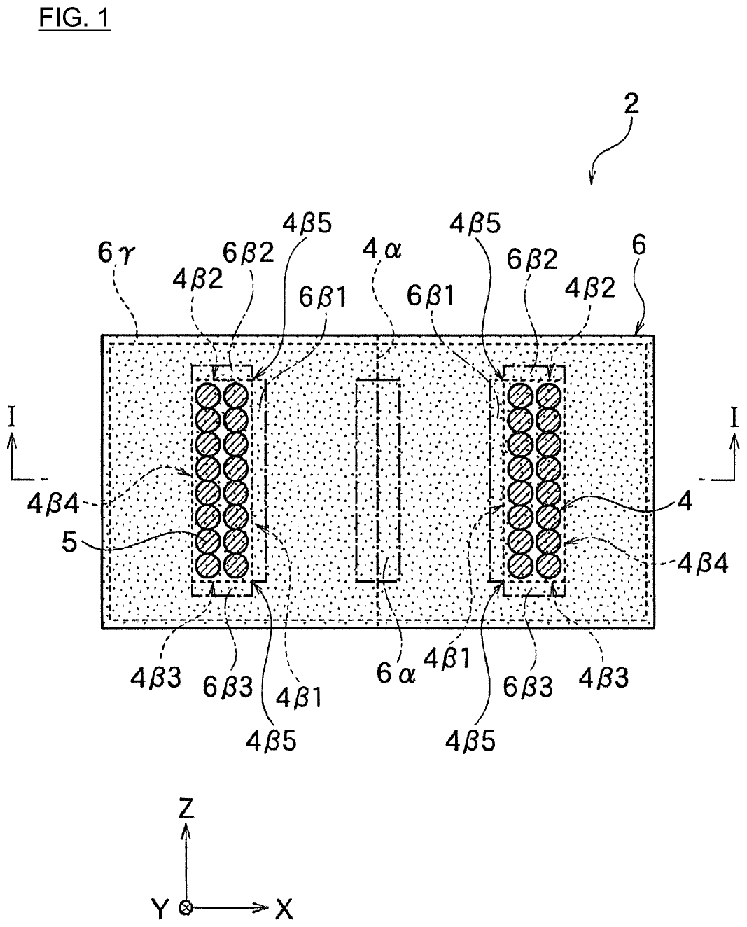

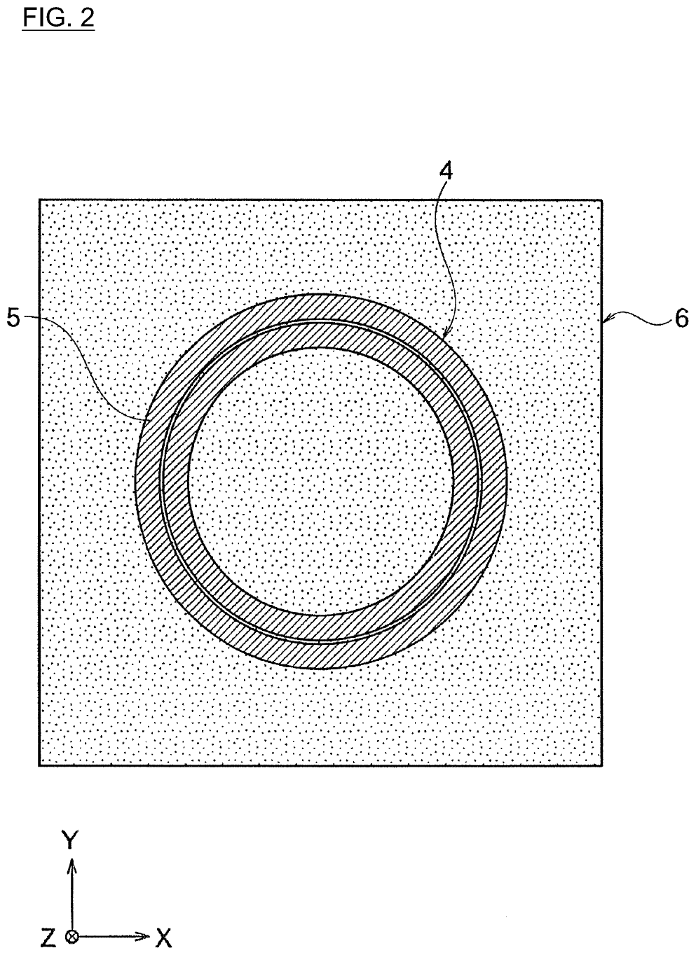

FIG. 1 shows a section that passes an axial centerline 4a of a winding portion 4 and is parallel to the axial centerline 4a. FIG. 2 is a sectional schematic view along line I-I shown in FIG. 1. As shown in FIGS. 1 and 2, an inductor 2, which is one type of a coil component according to one embodiment of the present disclosure, includes the winding portion 4 and a core portion 6. The winding portion 4 includes a conductor 5 wound in a coil shape.

An upper surface and a lower surface of the core portion 6 of the inductor 2 according to the one embodiment of the present disclosure are perpendicular to the Z-axis. Side surfaces of the core portion 6 are perpendicular to a plane containing the X-axis and the Y-axis. A winding axis of the winding portion 4 is parallel to the Z-axis. However, the core portion 6 may have any other shapes other than the shape shown in FIGS. 1 and 2.

In the present disclosure, “parallel” denotes not only a complete parallel state but also a substantially parallel state. That is, in some embodiments of the present disclosure, “parallel” denotes a state with variation within manufacturing tolerance. In some embodiments of the present disclosure, “parallel” denotes a state with variation exceeding the manufacturing tolerance. Specifically, a line A being parallel to a line B denotes that an angle formed by the lines A and B is 0° or more and 10° or less unless otherwise specified. The same applies to a situation where either one of the lines is or both of the lines are replaced with a plane or planes.

In the present disclosure, “perpendicular” denotes not only a complete perpendicular state but also a substantially perpendicular state. That is, in some embodiments of the present disclosure, “perpendicular” denotes a state with variation within manufacturing tolerance. In some embodiments of the present disclosure, “perpendicular” denotes a state with variation exceeding the manufacturing tolerance. Specifically, a line A being perpendicular to a line B denotes that an angle formed by the lines A and B is 80° or more and 100° or less unless otherwise specified. The same applies to a situation where either one of the lines is or both of the lines are replaced with a plane or planes.

The inductor 2 according to the embodiment of the present disclosure may have any size. In some embodiments, the inductor 2 has a size of a rectangular parallelepiped having a bottom surface measuring 2 mm×2 mm and a height of 1 mm as lower size limits of portions other than portions not shown in the drawings (e.g., lead portions or terminals described later). In some embodiments, the inductor 2 has a size of a cube having a bottom surface measuring 25 mm×25 mm and a height of 25 mm as upper size limits of the portions other than the portions not shown in the drawings. The height denotes a length in the Z-axis direction in FIG. 1. In FIGS. 1 and 2, illustration of the lead portions of the winding portion 4, the terminals, etc. is omitted. In some embodiments, the conductor constituting the winding portion 4 includes the lead portions at both ends. In some embodiments, the lead portions are drawn outside the core portion 6.

The conductor (conductive wire) 5 constituting the winding portion 4 is covered, at its periphery, with an insulating coating as necessary. The conductor 5 may be made from any material. In some embodiments, the conductor 5 is made from, for example, Cu, Al, Fe, Ag, Au, or an alloy containing some of these metals. The insulating coating may be made from any material. In some embodiments, examples of materials of the insulating coating include polyurethane, polyamide-imide, polyimide, polyester, polyester-imide, and/or polyester-nylon.

The conductor 5 may have any cross-sectional shape. Examples of cross-sectional shapes include a circular shape and a rectangular shape. In the embodiment of the present disclosure, the conductor 5 has a circular cross-sectional shape.

The core portion 6 includes at least soft magnetic metal particles. The soft magnetic metal particles may be made from any material. In some embodiments, examples of materials of the soft magnetic metal particles include ferrites (e.g., Mn—Zn ferrites and Ni—Cu—Zn ferrites) and soft magnetic alloys (e.g., Fe—Si alloys, Fe—Si—Al alloys, Fe—Si—Cr alloys, and permalloys (Fe—Ni alloys)). The soft magnetic metal particles may have any microstructure. In some embodiments, the microstructure of the soft magnetic metal particles is amorphous. In some embodiments, the microstructure of the soft magnetic metal particles includes crystals. In some embodiments, in a situation where the soft magnetic metal particles are amorphous, the soft magnetic metal particles are flattened in advance with a pulverizer or the like. In a situation where the soft magnetic metal particles include crystals, the crystals may have any crystal grain size. In some embodiments, the crystal grain size is, for example, 1 μm or less.

In some embodiments, the soft magnetic metal particles include Fe based soft magnetic particles, i.e., soft magnetic particles having an Fe content of 90 at % or more.

The soft magnetic metal particles in the core portion 6 may have any average particle size. In some embodiments, the soft magnetic metal particles observed in a section of the core portion 6 using a SEM have an average equivalent circle diameter of 1 μm or more and 100 μm or less. An equivalent circle diameter of a particle is a diameter of a circle having the same area as the particle. Hereinafter, an equivalent circle diameter of a particle in a section may simply be referred to as a particle size.

The soft magnetic metal particles include specific particles having a particle size of 10 μm or more and 50 μm or less. The specific particles may account for any percentage of the soft magnetic metal particles in the core portion 6. In some embodiments, the total area of the specific particles accounts for 50% or more of the total area of the soft magnetic metal particles in a section of the core portion 6.

In some embodiments, the core portion 6 includes a thermosetting resin (binder). The thermosetting resin may be of any type. Examples of thermosetting resins include an epoxy resin, a diallyl phthalate resin, a phenol resin, polyimide, polyamide-imide, a silicone resin, and a combination of some of these. In some embodiments, the core portion 6 includes an epoxy resin as the thermosetting resin.

The winding portion 4 includes an inner circumferential surface 4β1, an outer circumferential surface 4β4, and a first end surface 4β2 and a second end surface 4β3 opposite each other along the axial centerline 4a.

As shown in FIG. 1, the core portion 6 includes a wire inner circumference neighboring region 6β1, a first end-surface neighboring region 6β2, a second end-surface neighboring region 6β3, an axially central region 6α, and a peripheral region 6γ. The wire inner circumference neighboring region 6β1 is defined as a region within 100 μm from the inner circumferential surface 4β1 to the axial centerline 4α. The first end-surface neighboring region 6β2 is defined as a region within 100 μm outwards from the first end surface 4β2 parallelly to the axial centerline 4α. The second end-surface neighboring region 6β3 is defined as a region within 100 μm outwards from the second end surface 4β3 parallelly to the axial centerline 4α. The winding portion 4 is disposed perpendicularly outwards from the axial centerline 4α, and the axially central region 6α is defined as a region within 280 μm perpendicularly outwards from the axial centerline 4α. The peripheral region 6γ is defined as a region within 200 μm from a nearest surface of the core portion 6.

The core portion 6 may have any density. In some embodiments, the density is, for example, 5.00 g/cm³ or more and 7.00 g/cm³ or less.

In some embodiments, the axially central region 6α has a density higher than that of the peripheral region 6γ. With the density of the axially central region 6α being higher than the density of the peripheral region 6γ, the inductor 2 readily has improved DC superimposition characteristics.

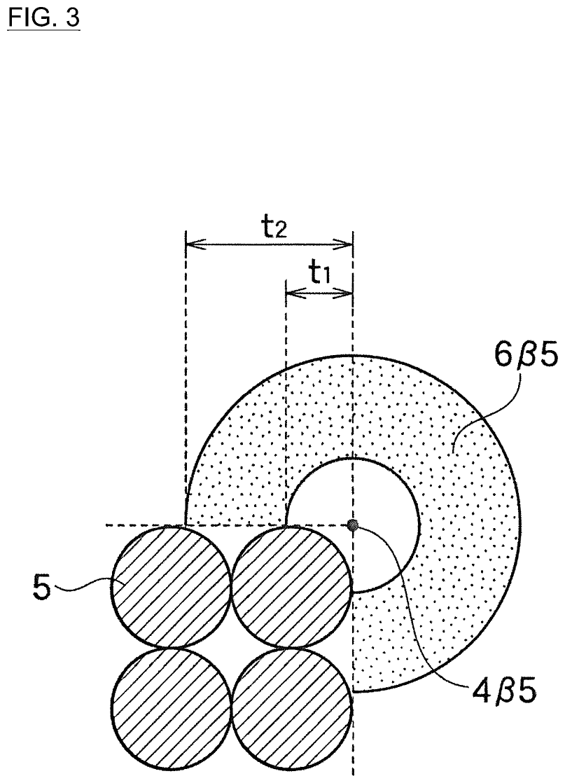

As shown in FIG. 1, a portion where the inner circumferential surface 4β1 and the first end surface 4β2 or the second end surface 4β3 meet is defined as a coil corner 4β5. As shown in FIG. 3, a portion where the distance from the coil corner 4β5 is 20 μm or more and 50 μm or less is defined as a coil corner neighboring region 6β5. That is, t₁=20 μm and t₂=50 μm are satisfied.

In some embodiments, 0<D1/D2<1.00 is satisfied, where D1 denotes an average inter-particle distance between the specific particles in the axially central region 6α and D2 denotes an average inter-particle distance between the specific particles in the coil corner neighboring region 6β5. In some embodiments, 0.01≤D1/D2≤0.99 is satisfied. In some embodiments, 0.19≤D1/D2≤0.70 is satisfied. In some embodiments, 0.19≤D1/D2≤0.66 is satisfied.

With D1/D2 being within the above range, the inductor 2 has high inductance and high DC superimposition characteristics. In a situation where D1/D2 is too high, particularly the DC superimposition characteristics are readily reduced.

In some embodiments, 0.20≤R1/R2≤5.00 is satisfied, where R1 denotes an average particle size of the specific particles in the axially central region 6α and R2 denotes an average particle size of the specific particles in the coil corner neighboring region 6β5. In some embodiments, 0.50≤R1/R2≤2.00 is satisfied. In some embodiments, 0.53≤R1/R2≤1.84 is satisfied.

With R1/R2 being within the above range, the inductor 2 readily has improved DC superimposition characteristics even if the difference between the density of the axially central region 6α and the density of the peripheral region 6γ is small (e.g., 0.20 g/cm³ or less).

Methods of measuring R1, R2, D1, and D2 are described below.

First, as shown in FIG. 1, the inductor 2 is cut to give a section that passes the axial centerline 4α and is parallel to the axial centerline 4α. Then, the axially central region 6α and the coil corner neighboring region 6β5 are observed using a SEM to give SEM images. The magnification and the size of the SEM images are not limited as long as the specific particles included in each region can be appropriately observed. In some embodiments, the magnification is, for example, ×10 to ×1000.

Then, the specific particles included in each region are identified. Any method of identifying the specific particles may be used. In some embodiments, the specific particles are identified visually. In some embodiments, the specific particles are identified using image analysis software.

In the axially central region 6α, particles that have a particle size of 10 μm or more and 50 μm or less and are included in the axially central region 6α in their entirety are defined as the specific particles. By contrast, in the coil corner neighboring region 6β5, particles that have a particle size of 10 μm or more and 50 μm or less and are at least partly included in the coil corner neighboring region 6β5 are defined as the specific particles.

### (D1 and D2)

In each region, an inter-particle distance between adjacent specific particles is measured. First, a line is drawn between surfaces of these different specific particles so that the line has a shortest length. The length of this line is the inter-particle distance between these adjacent specific particles.

The “adjacent specific particles” denote those whose line does not overlap any other soft magnetic metal particle having a particle size of 10 μm or more when the line is drawn.

In each region, all adjacent specific particles are identified, and their inter-particle distances are measured. Then, the measured inter-particle distances are averaged to calculate D1 or D2.

In some embodiments, the coil corner neighboring region 6β5 includes two coil corner neighboring regions 6β5 facing each other with respect to the axial centerline 4α. In some embodiments, in such a situation, 0<D1/D2<1.00 is satisfied in both of the two coil corner neighboring regions 6β5. The inductor 2 readily has improved DC superimposition characteristics.

In some embodiments, the coil corner neighboring region 6β5 includes four coil corner neighboring regions 6β5. In some embodiments, in such a situation, 0<D1/D2<1.00 is satisfied in all of the four coil corner neighboring regions 6β5. The inductor 2 readily has improved DC superimposition characteristics.

In particular, in a situation where the core portion 6 including a thermocompression-bonded soft magnetic metal powder is prepared to manufacture the inductor 2 having the shape shown in FIGS. 1 and 2, a magnetic flux is readily concentrated near an edge of the coil, i.e., the coil corner neighboring region 6β5, readily causing magnetic saturation.

Thus, to improve both inductance and DC superimposition characteristics of the inductor 2 as a whole, preferred is locally reducing permeability of the coil corner neighboring region 6β5 to less readily cause magnetic saturation. Thus, in this region, the inter-particle distances between the soft magnetic metal particles are preferably large.

By contrast, in a core central portion including the axially central region 6α, a magnetic path is preferably as short as possible so that a magnetic flux flows straight. Thus, preferred is locally increasing permeability of the core central portion. Thus, in the core central portion, the inter-particle distances between the soft magnetic metal particles are preferably small.

Thus, by satisfying 0<D1/D2<1.00 in the coil corner neighboring region 6β5, the inductor 2 readily has improved inductance and improved DC superimposition characteristics.

### (R1 and R2)

The particle sizes of all specific particles included in each region are measured. The measured particle sizes are averaged to calculate R1 or R2.

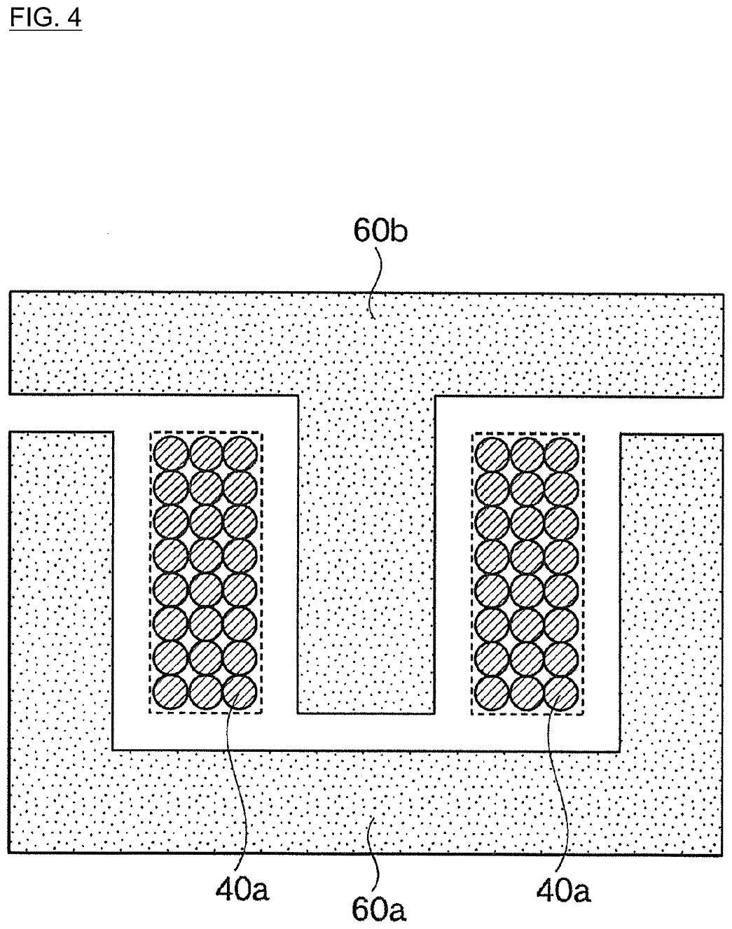

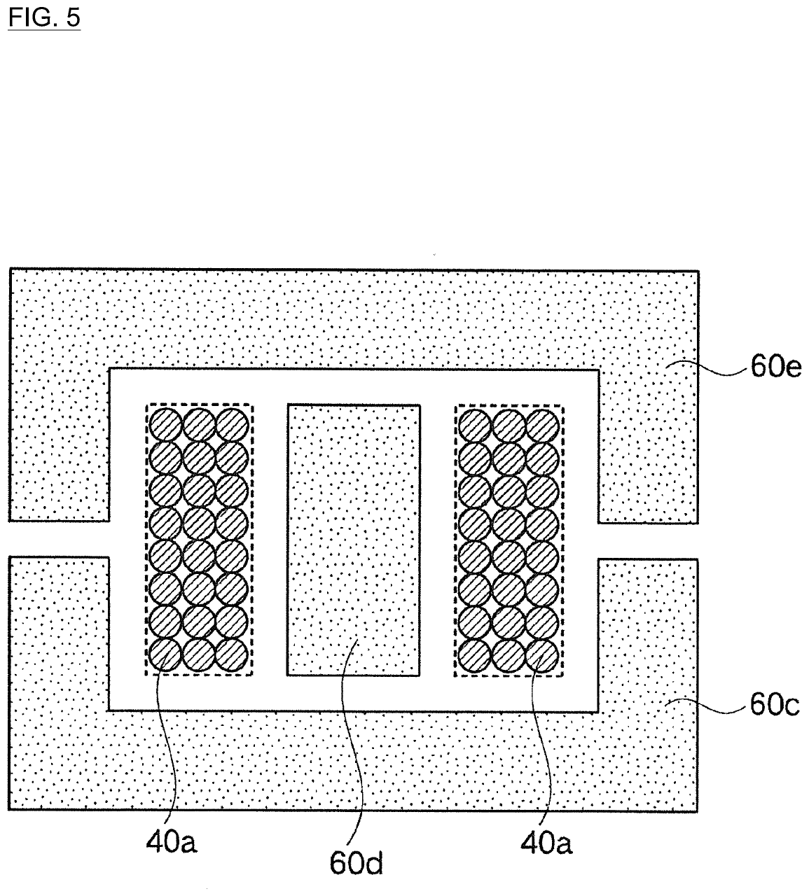

Methods of manufacturing the inductor 2 shown in FIG. 1 are described next with reference to FIGS. 4 and 5.

### (Manufacturing Method 1)

As shown in FIG. 4, the inductor 2 manufactured using a manufacturing method 1 of manufacturing the inductor 2 of the one embodiment of the present disclosure is manufactured by integrating two preliminary compact bodies 60a and 60b and an insert member 40a including the winding portion 4 constituting, for example, an air core coil.

### (Preliminary Compact Bodies)

As materials of the preliminary compact bodies 60a and 60b, a resin and a soft magnetic metal powder including soft magnetic metal particles are prepared.

The soft magnetic metal particles included in the soft magnetic metal powder may have any shapes. In some embodiments, the soft magnetic metal particles have, for example, a spherical shape. In some embodiments, the soft magnetic metal particles have a flat shape. In some embodiments, the soft magnetic metal particles have a needle-like shape.

In some embodiments, preparation of the preliminary compact bodies involves use of one soft magnetic metal powder. In some embodiments, two or more soft magnetic metal powders having different shapes, different average particle sizes, different compositions, or the like are mixed. In a situation where one soft magnetic metal powder is used, the soft magnetic metal powder may have any average particle size. In some embodiments, the average particle size is, for example, 1 μm or more and 100 μm or less. The average particle size is not limited as long as the powder includes many soft magnetic metal particles that have a particle size of 10 μm or more and 50 μm or less and readily become the specific particles.

In a situation where two or more soft magnetic metal powders are mixed for use, the soft magnetic metal powders may have any average particle sizes. In some embodiments, for example, a soft magnetic metal powder that is mainly to be the specific particles and has an average particle size of 10 μm or more and 50 μm or less and a soft magnetic metal powder that is mainly to be particles smaller than the specific particles and has an average particle size of 1 μm or more and less than 10 μm are mixed for use.

The resin may be of any type. Examples of resins include an epoxy resin, a phenol resin, a polyimide resin, a polyamide-imide resin, and a silicone resin. In some embodiments, a resin in which some of these resins are appropriately combined is prepared.

Next, the soft magnetic metal powder or powders and the resin are mixed and are granulated into granules. Any method of granulation may be used. In some embodiments, for example, the resin is added to the soft magnetic metal powder or powders, and the mixture is stirred and then dried. In some embodiments, an average size of the granules or granule size distribution is appropriately controlled.

The proportion of the resin is not limited. In some embodiments, the resin weighs, for example, 1.0 to 6.0 parts by weight with respect to 100 parts by weight of the soft magnetic metal powder or powders.

In some embodiments, before the soft magnetic metal powder or powders is or are mixed with the resin, an insulating film is provided on surfaces of the soft magnetic metal particles. In some embodiments, for example, a sol gel method is used to provide the insulating film, which is a SiO₂ film.

In some embodiments, after addition of the resin to the soft magnetic metal powder or powders and stirring, the stirred mixture is sieved with a mesh to remove coarse granules. In some embodiments, the resin is diluted with a solvent when added to the soft magnetic metal powder or powders. As the solvent, for example, ketone is used.

Next, compression molding is carried out to prepare the preliminary compact bodies 60a and 60b. Specifically, a mold is filled with the resulting granules, and pressure is applied, to give the preliminary compact bodies 60a and 60b. The preliminary compact bodies 60a and 60b prepared by compression molding are compact bodies including the soft magnetic metal particles and the resin.

The pressure applied is not limited. The higher the pressure, the larger and flatter the soft magnetic metal particles tend to be. In some embodiments, the pressure is, for example, 400 MPa to 1000 MPa.

In the manufacturing method 1, the preliminary compact body 60a has a pot-type shape as shown in FIG. 4. The preliminary compact body 60b has an RT-type shape.

### (Integration of Preliminary Compact Bodies and Insert Member)

First, the preliminary compact body 60a is inserted into a mold. Then, as shown in FIG. 4, the insert member 40a is disposed at a predetermined location above the preliminary compact body 60a. Then, the preliminary compact body 60b is disposed at a predetermined location above the preliminary compact body 60a and the insert member 40a. In some embodiments, before the preliminary compact body 60b is inserted into the mold, the mold is appropriately filled with a core material. Hereinafter, description is provided on the premise that the mold is not filled with the core material. As the number of turns in FIGS. 4 and 5 is different from that of FIGS. 1 and 2, in some embodiments, the number of turns is appropriately modified.

Then, thermocompression bonding is carried out. Specifically, after the preliminary compact bodies 60a and 60b inserted into the mold are heated to a temperature at which the resin softens, the preliminary compact bodies 60a and 60b and the insert member 40a are thermocompression-bonded. In some embodiments, the preliminary compact bodies 60a and 60b, the insert member 40a, etc. are heated (preheated) in advance. In some embodiments, the frame, punch, or the like of the mold are heated. The direction in which pressure is applied is the winding axis direction of the coil. By pressing, the winding portion 4 and the core portion 6 are thermocompression-bonded for integration. The preliminary compact bodies 60a and 60b are deformed by thermocompression bonding, and spaces shown in FIG. 4 are appropriately filled with the preliminary compact bodies 60a and 60b. The pressure of thermocompression bonding is not limited. The pressure is, for example, 100 MPa to 400 MPa. The temperature of thermocompression bonding is not limited. The temperature is, for example, 50° C. to 100° C.

By thermocompression bonding, the preliminary compact bodies 60a and 60b are integrated to give the core portion 6.

In some embodiments, the inductor 2 taken out from the mold after thermocompression bonding is heated to further cure the resin. The heating temperature at this time is not limited. In some embodiments, the heating temperature is, for example, 150° C. to 200° C.

### (Method of Controlling D1/D2)

In a situation where the inductor 2 shown in FIG. 1 is manufactured by thermocompression bonding of the preliminary compact bodies and the insert member 40a shown in FIG. 4 using the above method, the coil corner neighboring region 6β5 being within the predetermined range from the coil corner 4β5 where the inner circumferential surface 4β1 and the second end surface 4β3 shown in FIG. 1 meet is located near a portion where the preliminary compact body 60a having the pot-type shape and the preliminary compact body 60b having the RT-type shape are bonded.

Usually, the higher the density of the soft magnetic metal powder, the better the permeability of the core portion 6 of the inductor 2. Thus, the core portion 6 in its entirety preferably has a high density. Thus, to increase permeability, it is assumed that the preliminary compact body 60a having the pot-type shape and the preliminary compact body 60b having the RT-type shape are preferably combined without any spaces therebetween when the preliminary compact bodies 60a and 60b and the insert member 40a are combined.

In some embodiments, in the manufacturing method 1 of manufacturing the inductor 2 according to the one embodiment of the present disclosure, the preliminary compact body 60b having the RT-type shape is tapered at its extremity, i.e., a portion that is eventually located near the coil corner neighboring region 6β5. Tapering provides a space at the portion that is located near the coil corner neighboring region 6β5 when the preliminary compact bodies 60a and 60b and the insert member 40a are combined.

In a situation where the preliminary compact bodies including the soft magnetic metal particles and the resin are thermocompression-bonded, the resin exudes at a joint. In a situation where the extremity of the preliminary compact body 60b is tapered as described above, much of the resin exudes from the preliminary compact bodies 60a and 60b into the space provided by tapering. By contrast, the amount of the soft magnetic metal particles that move into this space from the preliminary compact bodies 60a and 60b is relatively small. Thus, at the space provided by tapering and its vicinity, the density of the soft magnetic metal particles is reduced, and the average inter-particle distance between the specific particles is increased. That is, at two coil corner neighboring regions 6β5 being within the predetermined range from two coil corners 4β5 where the inner circumferential surface 4β1 and the second end surface 4β3 meet in a section of the inductor 2, D2 is increased.

By contrast, the average inter-particle distance between the specific particles in the axially central region 6α almost does not vary according to presence or absence of the tapering. Thus, D1 almost does not vary according to presence or absence of the tapering.

Thus, providing the tapering can reduce D1/D2 of the two coil corner neighboring regions 6β5 being within the predetermined range from the two coil corners 4β5 where the inner circumferential surface 4β1 and the second end surface 4β3 meet in a section of the inductor 2 to less than 1.00. That is, in both two coil corner neighboring regions 6β5 facing each other with respect to the axial centerline 4a, 0<D1/D2<1.00 can be satisfied.

In addition to tapering, changing various conditions or the like of, in particular, thermocompression bonding can control D1/D2.

Controlling the temperature of thermocompression bonding can control D1/D2. As the temperature of thermocompression bonding is increased, the resin softens, and the amount of the resin exuding into the space increases. Consequently, D2 is further increased, which readily reduces D1/D2. Conversely, reducing the temperature of thermocompression bonding makes the resin harder, reducing the amount of the resin exuding into the space. By contrast, easiness of the soft magnetic metal particles to move into the space does not readily change. Consequently, even when the tapering is provided, D2 is not readily increased, and D1/D2 is less readily reduced.

Selecting a soft resin as the resin also allows the tapering to readily reduce D1/D2. Conversely, if a hard resin is selected as the resin, D1/D2 is less readily reduced regardless of the tapering being provided.

It is also possible to control D1/D2 by controlling the particle sizes of the soft magnetic metal particles included in the preliminary compact body 60a having the pot-type shape and/or the particle sizes of the soft magnetic metal particles included in the preliminary compact body 60b having the RT-type shape. Relatively reducing the particle sizes of the specific particles included in the preliminary compact body 60b having the RT-type shape readily reduces D1/D2.

Relatively reducing the particle sizes of the soft magnetic metal particles included in the preliminary compact body 60b having the RT-type shape reduces the particle sizes of the soft magnetic metal particles included in the axially central region 6α, reducing D1. By contrast, the soft magnetic metal particles from both of the preliminary compact bodies 60a and 60b μmove into the space provided by tapering. Thus, even when the particle sizes of the soft magnetic metal particles included in the preliminary compact body 60b having the RT-type shape are relatively reduced, D2 is not readily reduced as much as D1. Thus, relatively reducing the particle sizes of the specific particles included in the preliminary compact body 60b having the RT-type shape readily reduces D1/D2.

### (Manufacturing Method 2)

A manufacturing method 2 is described below. The manufacturing method 2 is similar to the manufacturing method 1 unless otherwise specified.

In the manufacturing method 2, FIG. 4 is turned upside down. Specifically, first, the preliminary compact body 60b is inserted into a mold. Then, the insert member 40a is disposed at a predetermined location above the preliminary compact body 60b. Then, the preliminary compact body 60a is disposed at a predetermined location above the preliminary compact body 60b and the insert member 40a.

In this situation, unlike the manufacturing method 1, the coil corner neighboring region 605 being within the predetermined range from the coil corner 4β5 where the inner circumferential surface 4β1 and the first end surface 4β2 shown in FIG. 1 meet is located near a portion where the preliminary compact body 60b having the RT-type shape and the preliminary compact body 60a having the pot-type shape are bonded. Providing the preliminary compact body 60b having the RT-type shape with the tapering can reduce D1/D2 of two coil corner neighboring regions 6β5 being within the predetermined range from two coil corners 4β5 where the inner circumferential surface 4β1 and the first end surface 4β2 meet in a section of the inductor 2 to less than 1.00. That is, in both two coil corner neighboring regions 6β5 facing each other with respect to the axial centerline 4α, 0<D1/D2<1.00 can be satisfied.

### (Manufacturing Method 3)

A manufacturing method 3 is described below. The manufacturing method 3 is similar to the manufacturing method 1 unless otherwise specified.

As shown in FIG. 5, the inductor 2 manufactured using the manufacturing method 3 of manufacturing the inductor 2 of the one embodiment of the present disclosure is manufactured by integrating three preliminary compact bodies 60c to 60e and an insert member 40a including the winding portion 4 constituting, for example, an air core coil.

### (Preliminary Compact Bodies)

The preliminary compact bodies 60c to 60e are similar to the preliminary compact bodies 60a and 60b except for their shapes.

In the manufacturing method 3, as shown in FIG. 5, the preliminary compact bodies 60c and 60e have a pot-type shape, and the preliminary compact body 60d has a cylindrical shape.

### (Integration of Preliminary Compact Bodies and Insert Member)

First, the preliminary compact body 60c is inserted into a mold. Then, as shown in FIG. 5, the insert member 40a and the preliminary compact body 60d are disposed at a predetermined location above the preliminary compact body 60c. Then, the preliminary compact body 60e is disposed at a predetermined location above the preliminary compact bodies 60c and 60d and the insert member 40a. The mold may be appropriately filled with a core material before the preliminary compact body 60d is inserted into the mold or before the preliminary compact body 60e is inserted into the mold. Hereinafter, description is provided on the premise that the mold is not filled with the core material.

Then, thermocompression bonding is carried out. Specifically, after the preliminary compact bodies 60c to 60e inserted into the mold are heated to a temperature at which the resin softens, the preliminary compact bodies 60c to 60e and the insert member 40a are thermocompression-bonded. The preliminary compact bodies 60c to 60e, the insert member 40a, etc. may be heated (preheated) in advance. The frame, punch, or the like of the mold may be heated. The direction in which pressure is applied is the winding axis direction of the coil. By pressing, the winding portion 4 and the core portion 6 are thermocompression-bonded for integration. The preliminary compact bodies 60c to 60e are deformed by thermocompression bonding, and spaces shown in FIG. 5 are appropriately filled with the preliminary compact bodies 60c to 60e.

By thermocompression bonding, the preliminary compact bodies 60c to 60e are integrated to give the core portion 6.

In the manufacturing method 3 of manufacturing the inductor 2 according to the one embodiment of the present disclosure, the preliminary compact body 60d having the cylindrical shape may be tapered at its extremities, i.e., portions that are eventually located near the coil corner neighboring region 6β5. The preliminary compact body 60d having the cylindrical shape may be tapered at its extremities. Tapering provides spaces at the portions that are located near the coil corner neighboring region 6β5 when the preliminary compact bodies 60c to 60e and the insert member 40a are combined.

In a situation where the preliminary compact bodies including the soft magnetic metal particles and the resin are thermocompression-bonded, the resin exudes at a joint. In a situation where the extremities of the preliminary compact body 60d are tapered as described above, much of the resin exudes from the preliminary compact bodies 60c to 60e into the spaces provided by tapering. By contrast, the amount of the soft magnetic metal particles that move into these spaces from the preliminary compact bodies 60c to 60e is relatively small. Thus, at the spaces provided by tapering the extremities at both sides of the preliminary compact body 60d and their vicinity, the density of the soft magnetic metal particles is reduced, and the average inter-particle distance between the specific particles is increased. That is, at two coil corner neighboring regions 6β5 being within the predetermined range from two coil corners 4β5 where the inner circumferential surface 4β1 and the first end surface 4β2 meet and at two coil corner neighboring regions 6β5 being within the predetermined range from two coil corners 4β5 where the inner circumferential surface 4β1 and the second end surface 4β3 meet in a section of the inductor 2, D2 is increased. That is, in all of the four coil corner neighboring regions 6β5 shown in FIG. 1, D2 is increased.

By contrast, the average inter-particle distance between the specific particles in the axially central region 6α almost does not vary according to presence or absence of the tapering. Thus, D1 almost does not vary according to presence or absence of the tapering.

Thus, providing the tapering can reduce D1/D2 of all four coil corner neighboring regions 6β5 to less than 1.00, allowing 0<D1/D2<1.00 to be satisfied.

In the manufacturing method 3, D1/D2 of all four coil corner neighboring regions 6β5 of the inductor 2 can be reduced to less than 1.00, allowing 0<D1/D2<1.00 to be satisfied. That is, inductance and DC superimposition characteristics of this inductor 2 are more readily improved than when the manufacturing method 1 or 2 is used.

### (Other Manufacturing Methods)

Methods of manufacturing the inductor 2 according to the present disclosure are not limited to those described above. In particular, the shapes and the number of cores are not limited as long as the inductor 2 shown in FIG. 1 is eventually obtained. Also, as described in the present disclosure, in some embodiments, the inductor 2 is an integrally-molded coil component, i.e., a coil component entirely sealed in resin except for a lead portion of a wire.

Coil components according to the present disclosure are not limited to inductors. In some embodiments, for example, the coil components are coil components such as transformers or reactors. However, a fact that the coil components according to the present disclosure readily have improved inductance and a fact that it is difficult for a transformer or a reactor to be integrally molded being considered, the coil components according to the present disclosure are inductors in some embodiments.

A power supply apparatus according to the present disclosure includes the above coil component. In some embodiments, the power supply apparatus is, for example, a power supply such as a switching power supply or a power amplifier.

### EXAMPLES

Hereinafter, the present disclosure is described based on further detailed examples. However, the present disclosure is not limited to these examples.

A method of manufacturing inductor samples of Examples and Comparative examples shown in Table 1 is described.

First, preliminary compact bodies 60a and 60b having respective shapes shown in FIG. 4 were prepared. Further, an insert member 40a including a winding portion 4, lead-out wires, and terminals was prepared. Note that, in FIG. 4, illustration of the lead-out wires and the terminals is omitted.

### (Preliminary Compact Bodies)

As materials of the preliminary compact body 60a, a resin and a soft magnetic metal powder including soft magnetic metal particles were prepared. The soft magnetic metal particles were made from an Fe—Si alloy (Fe 93.5 wt %, Si 6.5 wt %). The soft magnetic metal powder had a particle size such that R2 was as shown in Table 1. As the resin, an epoxy resin was used.

Then, an insulating film was provided on surfaces of the soft magnetic metal particles. Specifically, a sol gel method was used to provide the insulating film, which was a SiO₂ film. The insulating film had a thickness of about 4βnm.

Next, the soft magnetic metal powder and the resin were mixed and were granulated into granules. Specifically, the resin was added to the soft magnetic metal powder, and the mixture was stirred and then dried at 4β° C. for 10 hours. With regard to the proportion of the resin, the resin weighed 2 to 3 parts by weight with respect to 100 parts by weight of the soft magnetic metal powder. The type of the resin was the epoxy resin. After addition of the resin to the soft magnetic metal powder and stirring, the stirred mixture was sieved with a mesh to remove coarse granules. Specifically, the mixture was sieved with a mesh with an opening of 100 μm. Eventually resulting granules had an average size of about 60 μm.

Next, a mold was filled with the resulting granules, and a core was molded, to give the preliminary compact body 60a having a pot-type shape shown in FIG. 4. The molding pressure was 6 ton/cm². The preliminary compact body 60a had a density such that D2 was as shown in Table 1.

The preliminary compact body 60b having an RT-shape shown in FIG. 4 was prepared under the same conditions as the preliminary compact body 60a except for the shape and the particle size of the soft magnetic metal powder. The soft magnetic metal powder of the preliminary compact body 60b had a particle size such that R1, R2, and R1/R2 were as shown in Table 1. The preliminary compact body 60b had a density such that D1, D2, and D1/D2 were as shown in Table 1.

In each Example, the preliminary compact body 60b was appropriately tapered at its extremity so that D1/D2 was as shown in Table 1.

### (Insert Member)

The winding portion 4 of the insert member 40a had an outside diameter of 4.67 mm, an inside diameter of 2.80 mm, a wire diameter (diameter of a conductor 5) of 0.22 mm, a number of turns N of 61.5 ts., and a height H of 4.16 mm. The conductor 5, the lead-out wires, and the terminals were made from Cu.

### (Integration of Preliminary Compact Bodies and Insert Member)

First, the preliminary compact body 60a was inserted into a mold. Then, as shown in FIG. 4, the insert member 40a and the preliminary compact body 60b were disposed at a predetermined location.

Then, thermocompression bonding was carried out. Specifically, after the preliminary compact bodies 60a and 60b and the insert member 40a inserted into the mold were heated at 80° C. to soften the resin, pressure was applied to them. The direction in which pressure was applied was a winding axis direction of the coil. By pressing, the coil and the preliminary compact bodies were thermocompression-bonded for integration. The molding pressure of thermocompression bonding was 100 MPa.

Each inductor 2 taken out from the mold after molding by thermocompression bonding was heated to cure the resin. The heating temperature was 150° C. to 200° C. The heating time was 1 hour to 3 hours. The heating temperature and the heating time were appropriately controlled so that D1/D2 was as shown in Table 1.

The above steps gave the inductor 2 shown in FIG. 1. The core portion 6 of the inductor 2 had a dimension of 5.50 mm×5.50 mm×5.15 mm (height).

R1, R2, D1, and D2 of each sample inductor were calculated using sectional SEM images of the inductor cut in a section containing an axial centerline. Table 1 shows the results. The magnification of the SEM images was ×500. R2 and D2 were measured in two coil corner neighboring regions 6β5 being within a predetermined range from two coil corners 405 where an inner circumferential surface 4β1 and a second end surface 4β3 met in the section. It was confirmed that R2 was the same between the two coil corner neighboring regions 6β5 and that D2 was the same between the two coil corner neighboring regions 6β5. In calculation of R1 and R2, the soft magnetic metal particles having a particle size of less than 10 μm or a particle size exceeding 50 μm were not taken into account. In calculation of D1 and D2, the soft magnetic metal particles having a particle size of less than 10 μm were not taken into account.

Inductance L0 of each sample before a direct current was applied was measured. L0 was measured using an RF impedance material analyzer (4491A manufactured by Agilent Technologies) at a measurement frequency of 1.0 MHz and a measurement voltage of 500 μmV. Table 1 shows the results.

Isat of each sample was measured to evaluate DC superimposition characteristics. Specifically, with a direct current starting from 0 being applied to each inductor, the direct current at which inductance was reduced to 0.8×L0 (inductance at a direct current of 0) was defined as Isat. Table 1 shows the results.

For each sample, L0×Isat was calculated. Table 1 shows the results. When L0× Isat was 6.0 (H×A) or more, inductance and DC superimposition characteristics were defined as good. Table 1 shows the results.

Using an X-ray density distribution measuring apparatus, it was confirmed in all samples that an axially central region 6α had a density higher than that of a peripheral region 6γ and that difference between the density of the axially central region 6α and the density of the peripheral region 6γ was 0.20 g/cm³ or less.

TABLE 1

| | | | | | | | | | | L0 × |
|---|---|---|---|---|---|---|---|---|---|---|
| Sample | Example/ | R1 | R2 | R1/ | D1 | D2 | D1/ | L0 | Isat | Isat |
| No. | Comparative example | [μm] | [μm] | R2 | [μm] | [μm] | D2 | [H] | [A] | [H × A] |
| 1 | Example | 26.6 | 26.9 | 0.99 | 10.5 | 15.9 | 0.66 | 0.96 | 7.5 | 7.2 |
| 2 | Example | 26.8 | 26.5 | 1.01 | 9.9 | 28.7 | 0.34 | 0.96 | 8.0 | 7.7 |
| 3 | Example | 27.3 | 26.9 | 1.01 | 10.2 | 49.9 | 0.20 | 0.94 | 8.9 | 8.4 |
| 4 | Example | 26.5 | 26.4 | 1.00 | 26.1 | 51.3 | 0.51 | 0.90 | 7.7 | 6.9 |
| 5 | Comparative example | 26.5 | 27.1 | 0.98 | 48.7 | 47.9 | 1.02 | 0.85 | 5.0 | 4.3 |
| 6 | Comparative example | 21.5 | 39.3 | 0.55 | 9.9 | 9.8 | 1.01 | 1.00 | 5.0 | 5.0 |
| 7 | Example | 21.3 | 39.5 | 0.54 | 10.2 | 16.4 | 0.62 | 0.96 | 7.5 | 7.2 |
| 8 | Example | 21.6 | 40.0 | 0.54 | 10.3 | 27.9 | 0.37 | 0.96 | 8.1 | 7.8 |
| 9 | Example | 20.9 | 39.6 | 0.53 | 9.7 | 50.3 | 0.19 | 0.94 | 9.2 | 8.6 |
| 10 | Example | 21.3 | 39.6 | 0.54 | 27.2 | 48.9 | 0.56 | 0.90 | 7.7 | 6.9 |
| 11 | Example | 39.3 | 21.9 | 1.79 | 10.4 | 16.7 | 0.62 | 0.96 | 7.5 | 7.2 |
| 12 | Example | 39.3 | 21.5 | 1.83 | 10.2 | 31.5 | 0.32 | 0.96 | 8.1 | 7.8 |
| 13 | Example | 39.8 | 21.8 | 1.83 | 9.9 | 46.9 | 0.21 | 0.94 | 8.9 | 8.4 |
| 14 | Example | 39.5 | 21.5 | 1.84 | 27.4 | 48.5 | 0.56 | 0.90 | 7.8 | 7.0 |
| 15 | Comparative example | 39.1 | 21.9 | 1.79 | 48.4 | 47.9 | 1.01 | 0.85 | 5.1 | 4.3 |
| 16 | Comparative example | 28.1 | 27.6 | 1.02 | 31.2 | 10.5 | 2.97 | 0.90 | 5.4 | 4.9 |
| 17 | Comparative example | 27.5 | 38.5 | 0.71 | 30.9 | 17.1 | 1.81 | 0.88 | 5.2 | 4.6 |
| 18 | Comparative example | 21.2 | 39.1 | 0.54 | 49.9 | 40.5 | 1.23 | 0.86 | 5.0 | 4.3 |

According to Table 1, the coil components satisfying 0<D1/D2<1.00 had higher L0×Isat, better inductance, and better DC superimposition characteristics than the coil components satisfying D1/D2≥1.00.

### [Additional Notes]

The technology of the present disclosure includes the following example configurations but may include any other configurations.

[1]A coil component including:
a core portion including soft magnetic metal particles and a resin; and
a winding portion including a conductor wound,
in which
the winding portion is inside the core portion;
the winding portion includes an inner circumferential surface, an outer circumferential surface, and an end surface;
the core portion includes an axially central region and a coil corner neighboring region; the axially central region is located in a region within a predetermined range
perpendicularly outwards from an axial centerline of the winding portion;
the coil corner neighboring region is within a predetermined range from a coil corner
where the inner circumferential surface and the end surface meet;
the soft magnetic metal particles include specific particles having a particle size of 10 μm or more and 50 μm or less; and
0<D1/D2<1.00 is satisfied, where D1 denotes an average inter-particle distance between the specific particles in the axially central region and D2 denotes an average inter-particle distance between the specific particles in the coil corner neighboring region.

[2] The coil component according to [1] satisfying 0.20≤R1/R2≤5.00, where R1 denotes an average particle size of the specific particles in the axially central region and R2 denotes an average particle size of the specific particles in the coil corner neighboring region.

[3] The coil component according to [1] or [2], in which
the core portion includes a peripheral region where an inward distance from a surface of
the core portion is within a predetermined range; and
the axially central region has a density higher than that of the peripheral region.

[4] The coil component according to [3], in which difference between the density of the axially central region and that of the peripheral region is 0.20 g/cm³ or less.

[5] The coil component according to any one of [1] to [4], in which the soft magnetic metal particles include Fe based soft magnetic particles.

[6] The coil component according to any one of [1] to [5], in which the resin includes an epoxy resin.

[7] The coil component according to any one of [1] to [6], in which
the coil corner neighboring region includes two coil corner neighboring regions facing each other with respect to the axial centerline; and
0<D1/D2<1.00 is satisfied in both of the two coil corner neighboring regions.

[8] The coil component according to any one of [1] to [7], in which
the coil corner neighboring region includes four coil corner neighboring regions; and
0<D1/D2<1.00 is satisfied in all of the four coil corner neighboring regions.

[9] The coil component according to any one of [1] to [8] satisfying 0.19<D1/D2<0.70.

[10]A power supply apparatus including the coil component according to any one of [1] to [9].

### REFERENCE NUMERALS

2 . . . inductor
4 . . . winding portion
4α . . . axial centerline
4β1 . . . inner circumferential surface
4β2 . . . first end surface
4β3 . . . second end surface
4β4 . . . outer circumferential surface
4β5 . . . coil corner
5 . . . conductor
6 . . . core portion
6α . . . axially central region
6β1 . . . wire inner circumference neighboring region
6β2 . . . first end-surface neighboring region
6β3 . . . second end-surface neighboring region
6β5 . . . coil corner neighboring region
67 . . . peripheral region
40a . . . insert member
60a to 60e . . . preliminary compact body

What is claimed is:

1. A coil component comprising:
a core portion comprising soft magnetic metal particles and a resin; and
a winding portion comprising a conductor wound,
wherein
the winding portion is inside the core portion;
the winding portion comprises an inner circumferential surface, an outer circumferential surface, and an end surface;
the core portion comprises an axially central region and a coil corner neighboring region;
the axially central region is located in a region within a predetermined range perpendicularly outwards from an axial centerline of the winding portion;
the coil corner neighboring region is within a predetermined range from a coil corner where the inner circumferential surface and the end surface meet;
the soft magnetic metal particles comprise specific particles having a particle size of 10 μm or more and 50 μm or less; and
0<D1/D2<1.00 is satisfied, where D1 denotes an average inter-particle distance between the specific particles in the axially central region and D2 denotes an average inter-particle distance between the specific particles in the coil corner neighboring region.

2. The coil component according to claim 1 satisfying 0.20≤R1/R2≤5.00, where R1 denotes an average particle size of the specific particles in the axially central region and R2 denotes an average particle size of the specific particles in the coil corner neighboring region.

3. The coil component according to claim 1, wherein
the core portion comprises a peripheral region where an inward distance from a surface of the core portion is within a predetermined range; and
the axially central region has a density higher than that of the peripheral region.

4. The coil component according to claim 3, wherein difference between the density of the axially central region and that of the peripheral region is 0.20 g/cm³ or less.

5. The coil component according to claim 1, wherein the soft magnetic metal particles comprise Fe based soft magnetic particles.

6. The coil component according to claim 1, wherein the resin comprises an epoxy resin.

7. The coil component according to claim 1, wherein
the coil corner neighboring region comprises two coil corner neighboring regions facing each other with respect to the axial centerline; and
0<D1/D2<1.00 is satisfied in both of the two coil corner neighboring regions.

8. The coil component according to claim 1, wherein
the coil corner neighboring region comprises four coil corner neighboring regions; and
0<D1/D2<1.00 is satisfied in all of the four coil corner neighboring regions.

9. The coil component according to claim 1 satisfying 0.19≤D1/D2≤0.70.

10. A power supply apparatus comprising the coil component according to claim 1.
